(19) United States
(12) Patent Application Publication
(10) Pub. No.: US 2006/0251245 A1
(43) Pub. Date: Nov. 9, 2006

(54) Device for automatically flipping handset cover

(76) Inventor: Sunney Yang, Chicago, IL (US)

Correspondence Address: HDSL, 4331 STEVENS BATTLE LANE, FAIRFAX, VA, 22033, US

(21) Appl. No.: 11/119,883

(22) Filed: May 3, 2005

(51) Int. Cl. H04M 1/00

(52) U.S. Cl. 379/452

(57) ABSTRACT

A device for automatically flipping a handset cover, which is disposed between the main body and the cover of a foldable handset, includes an actuating member, and a rotating member movably connected to the actuating member. In addition, a reciprocating member is movably connected to one end of the rotating member. In this manner, the user can simply use one single hand to operate the actuating member, thereby push the rotating member and then driving the reciprocating member to induce a rotational movement, so as to flip up the handset cover for users to pick up a phone call.

### BACKGROUND OF THE INVENTION

The present invention relates generally to a device for automatically flipping a handset cover, and more particularly to a device that is disposed between the main body and the cover of a foldable handset, which allows user to open the cover quickly and pick up a phone call.

Cellular phone handset has become one of the must-have products for modern people. Almost each person owns at least one handset. Among the various types of handsets, the foldable handsets are the most popular type for consumers. However, the conventional foldable handsets only use a shaft (axis) to connect the main body and the cover. The user should use one hand to hold the handset and use the other hand to flip up the cover, so as to pick up a phone call. This is quite inconvenient, especially when the user is busy taking care of other business at the time when there is an incoming call. If the user can not flip open the handset by using both hands, it is very likely that some important phone calls will be missed. On the other hand, when the user tries to flip open the handset in such a short time, it is likely that the user carelessly drops the handset, thereby damaging the handset.

### BRIEF SUMMARY OF THE INVENTION

The present invention is to provide a device for automatically flipping a handset cover so as to overcome the drawbacks of the conventional handsets. The user can simply use one hand to operate an actuating member to push a rotating member, thereafter driving a reciprocating member to induce a rotational movement, thereby flipping up the handset cover for users to pick up a phone call.

In order to achieve the above and other objectives, the device for automatically flipping up a handset cover of the present invention disposed between the main body and the cover of a foldable handset includes an actuating member, and a rotating member movably connected to the actuating member. In addition, a reciprocating member is movably connected to one end of the rotating member.

### BRIEF DESCRIPTION OF THE DRAWINGS

FIG. 1 is a perspective view of a device for automatically flipping a handset cover, in accordance with the first embodiment of the present invention.

FIG. 2 is an explosive view of the device, in accordance with the first embodiment of the present invention.

FIG. 3 is a schematic diagram of the device in combination with a handset, in accordance with the first embodiment of the present invention.

FIG. 4A to FIG. 4E illustrate sectional views of motion capture of the device, in accordance with the first embodiment of the present invention.

FIG. 5 is a side elevation of the device in use, in accordance with the first embodiment of the present invention.

FIG. 6 is a perspective view of a device for automatically flipping a handset cover, in accordance with the second embodiment of the present invention.

FIG. 7A to FIG. 7D illustrate sectional views of motion capture of the device, in accordance with the second embodiment of the present invention.

FIG. 8 is a perspective view of a device for automatically flipping a handset cover, in accordance with the third embodiment of the present invention.

FIG. 9 is a sectional view of the device, in accordance with the third embodiment of the present invention.

FIG. 10 is a perspective view of the device for automatically flipping a handset cover, which includes an actuating element.

### DETAILED DESCRIPTION OF THE INVENTION

In order to better understanding the features and technical contents of the present invention, the present invention is hereinafter described in detail by incorporating with the accompanying drawings. However, the accompanying drawings are only for the convenience of illustration and description, no limitation is intended thereto.

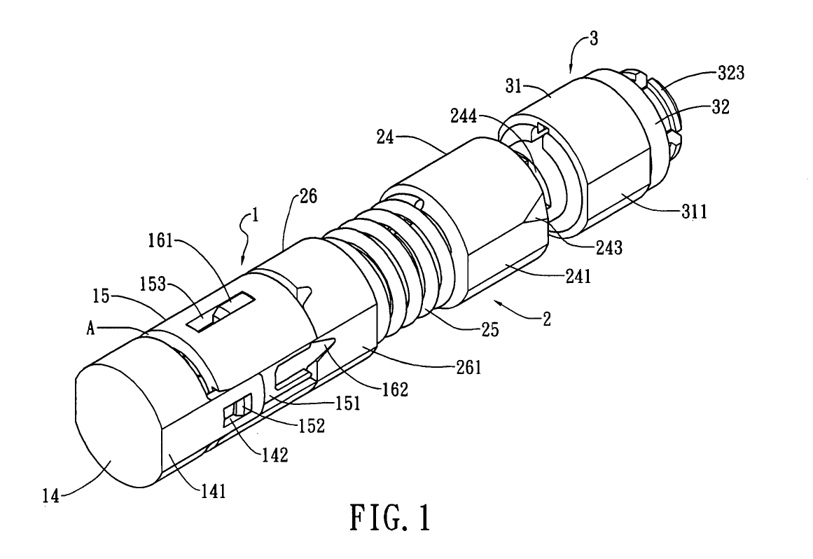

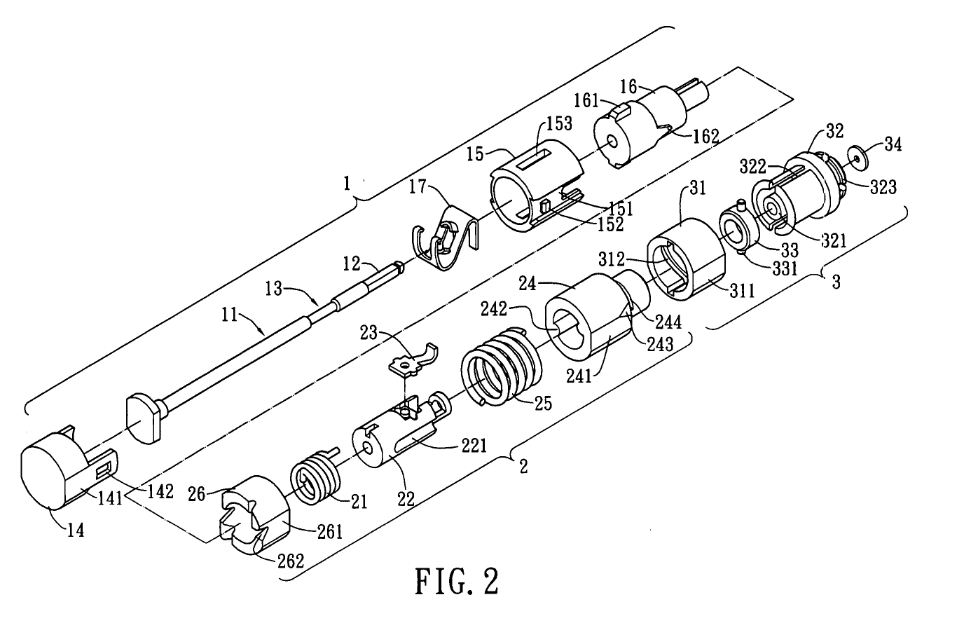

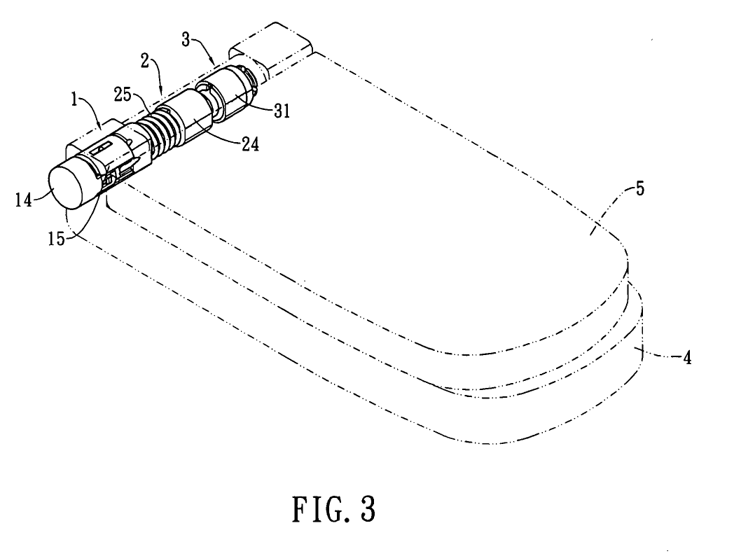

Referring to FIG. 1 and FIG. 2, a perspective view and an explosive of a device for automatically flipping a handset cover, in accordance with the first embodiment of the present invention, are illustrated. The device for automatically flipping a handset cover includes an actuating member 1, a rotating member 2, and a reciprocating member 3. The flipping device is disposed between the main body 4 and the cover 5 of a foldable handset, as shown in FIG. 3. Therefore, the user can use only one hand to operate the actuating member 1, thereby pushing the rotating member 2 and the reciprocating member 3 to flip open the cover of the handset. The user can then pick up the incoming phone call.

The actuating member described above includes an axial rod 11 disposed between the rotating member 2 and the reciprocating member 3. One end of the axial rod 11 includes a pillar 12 formed thereon. The pillar 12 can be a square pillar, polygonal pillar, or pillars of other geometrical forms. A narrowed section 13 is formed at the central portion of the axial rod 11. An actuating cap 14 is disposed on one tip of the axial rod 11. A button 15 is connected with the actuating cap 14. The outer rim of both the above two elements includes positioning portions 141, 151. The positioning portions 141, 151 can be a single flat surface, two mutually parallel flat surfaces, protrusive surface, or any other kind of surface that can limit the rotation. In this particular embodiment, the positioning portions 141, 151 are two mutually parallel flat surfaces. In addition, the actuating cap 14 includes two groove holes 142, while the button 15 includes protrusive portions 152 corresponding to the groove holes 142. The length of the groove holes 142 is larger than that of the protrusive portions 152, thereby making the actuating cap 14 and the button 15 to move correspondingly. A positioning axis harness 16 is disposed in the button 15 and is thrust in the positioning axis harness 16. Furthermore, a long groove 153 is correspondingly formed on the button 15. A protrusive piece 161 is formed on the positioning axis harness 16, so as to connect with the long groove 153 correspondingly. The length of the long groove 153 is larger than that of the protrusive piece 161. An elastic element 17 is thrust in the axial rod 11 and is support on the end surface of the positioning axis harness 16.

The rotating member 2 is movably connected with the actuating member 1 described above, so as to allow the actuating member 1 to drive the rotating member 2. The rotating member 2 includes a torque spring 21 connected with the positioning axis harness 16 of the actuating member 1. The other end of the torque spring 21 connected with a torque head 22. The torque head 22 is connected with a hook 23 and is contained in a pre-rotated head 24, while the axial rod 11 described above is penetrated therethrough. The outer rim of the pre-rotated head 24 includes a positioning portion 241 formed thereon. The positioning portion 241 can be a single flat surface, two mutually parallel flat surfaces, protrusive surface, or any other kind of surface that can limit the rotation. In this particular embodiment, the positioning portions are two mutually parallel flat surfaces. In order to achieve the pre-rotating purpose of the torque spring 21, the torque head 22 includes two corresponding concave grooves 221. In addition, a protrusive portion 221 is formed at the inner wall of the pre-rotated head 24 corresponding to the concave groove 221. However, the protrusive portion 242 and the concave groove 221 are disposed having a shifted angle between each other. Moreover, a taper horn 243 is disposed on the diagonal corners of the positioning portion 241 of the pre-rotated head 24. The taper horn 243 will automatically be rotated to form a pre-rotation when the device for automatically flipping handset cover of the present invention is inserted to the hollow axial hole of the handset cover 5. At the center portion of the pre-rotated head 24, a long groove 244 is formed to provide the hook 23 to connect thereon. In addition, a compressive spring 25 is disposed between the pre-rotated head 24 and the positioning nut 26. The compressive spring 25 is disposed surrounding the torque head 22. The positioning nut 26 includes a positioning portion 261 formed on the outer rim thereof, and is thrust in the positioning axis harness 16. The front rim thereof is disposed corresponding to one end of the button 15. In addition, the positioning axis harness 16 includes a locking portion 162. The locking portion 162 corresponds with the notch 262 of the positioning nut 26. The locking position determines the opening angle of the flipped handset cover.

The reciprocating member 3 is movably connected to the back end of the rotating member 2. The reciprocating member 3 includes a inner track nut 31 pivotally connected to the rotating member 2. The inner track nut 31 includes a positioning portion 311 formed at the outer rim thereof, and the inner wall thereof includes a threaded track 312. The inner track nut 31 is thrust into the outer rim of a fastening head 32. The fastening head 32 provides the pillar 12 of the axial rod 11 to penetrate therethrough, while a circular shaft 321 is disposed at the central portion thereof. The rim of the fastening head 32 does not contact the hollow axial hole of the cover 5, while two cropping grooves 322 are formed thereon. In addition, a slipping piece 33 is disposed between the inner track harness 31 and the fastening head 32. The slipping piece 33 includes two protrusive pillars 331 extended from the rim thereof. The slipping piece 33 is connected to the circular shaft 321 of the fastening head 32. The rim of the two protrusive pillars 331 are penetrated through the cropping grooves 332 of the fastening head 32, and the threaded track 312 of the inner wall of the inner track harness 31. An elastic mushroom head 323 is disposed at the right hand side of the fastening head 32. The mushroom head 323 can also be locked into the hollow axis hole of the cover 5 by other means. Finally, a locking ring 34 is added to lock in the concave groove of the pillar 12, thereby forming a device for automatically flipping up a handset cover.

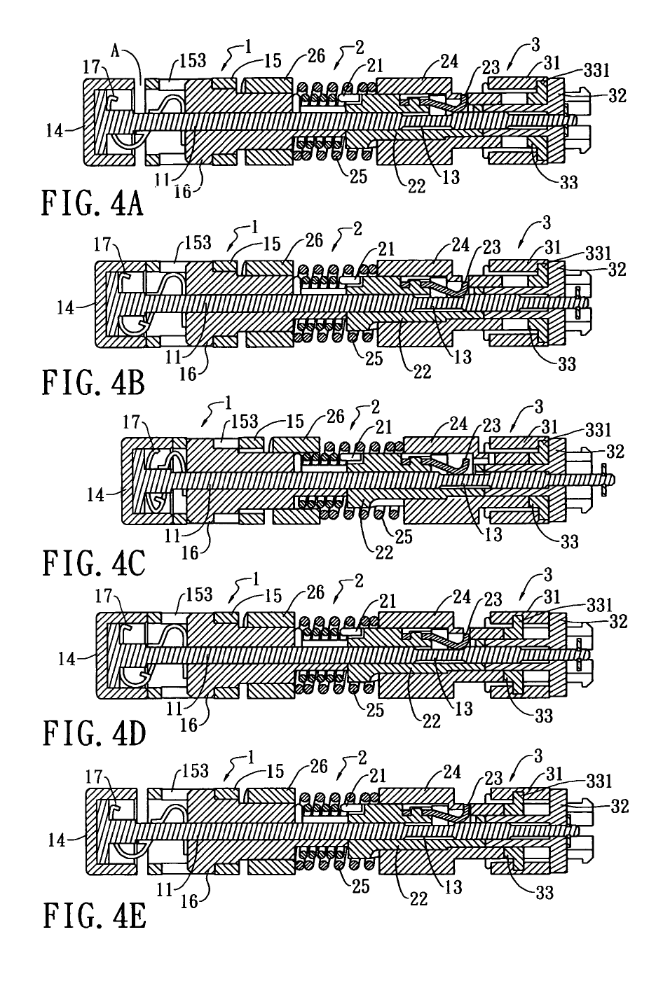

Referring to FIG. 3 and FIG. 4A to FIG. 4E, a schematic diagram and sectional motion capture views of a device for automatically flipping up a handset cover, in accordance with the first embodiment of the present invention, are illustrated. The device for automatically flipping up a handset cover is disposed between the main body 4 and the cover 5 of a handset. The actuating member 1 is contained in the left frame of the main body 4, while the rotating member 2 and the reciprocating member 3 are contained in the hollow axial hole (shown in FIG. 3) of the cover 5. Referring to FIG. 4A and FIG. 4B, the actuating cap 14 and the button 15 are normally separated with a distance A between the two end surfaces thereof. When the user operates on the actuating cap 14 of the actuating member 1, the operation is divided into two stages. In the first stage, the operation pressure is reduced. The actuating cap 14 moves along one fixed direction with the incorporation of the groove holes 143 and the protrusion portion 152 of the button 15. The end surface of the actuating cap 14 then approaches and contacts the end surface of the button 15. Meanwhile, the concave portion 13 of the axial rod 11 moves towards the right, making the hook 23 of the torque head 22 to elastically fall down without locking on the pre-rotated head anymore. Referring to FIG. 4C to FIG. 4E, when the actuating cap 14 continuously pushes forward to the second stage, the end surface of the button 15 pushes the positioning nut 26 moving to the right. Meanwhile, the compressive spring 25 between the positioning nut 26 and the pre-rotated head 24 will push the pr-rotating head 24 moving to the right, until the end of pre-rotated head 24 contacts the slipping piece 33. In this manner, the pressure exerted on the button 15 will be reduced, thereby easily pushing the positioning nut 26 away from the locking portion 162 of the positioning axis nut 16. In the mean time, the pre-rotated torque spring 21 is released from constraint, thereby rotating the pre-rotated head 24 via the torque head 22, and driving the positioning nut 26 and the inner track nut 31 to flip up the cover 5. When the cover 5 is flipped up, the inner track nut 31 will rotate with the cover 5. The threaded track 312 will drive the slipping piece 33 to move towards the left about the axis, push the pre-rotated head 24 to compress the compressive spring 25 redrawing back to the original position, and be locked again by the hook 23. The cover 5 is now flipped to a predetermined angle, such as 130 degrees or 170 degrees.

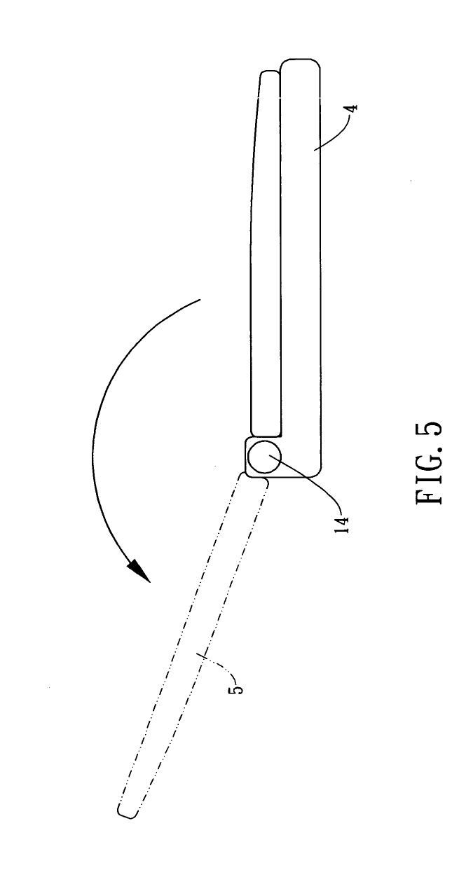

Referring to FIG. 5, when the cover 5 is collected up, the slipping piece 33 will be guided again by the threaded track 312 and go back to the original right most location. On the other hand, the torque spring 21 will be pre-rotated to the notch 262 of the positioning nut 26, and is locked at the locking portion 162 of the positioning axial harness 16. In this manner, the handset can be flipped up repeatedly by operating the actuating member.

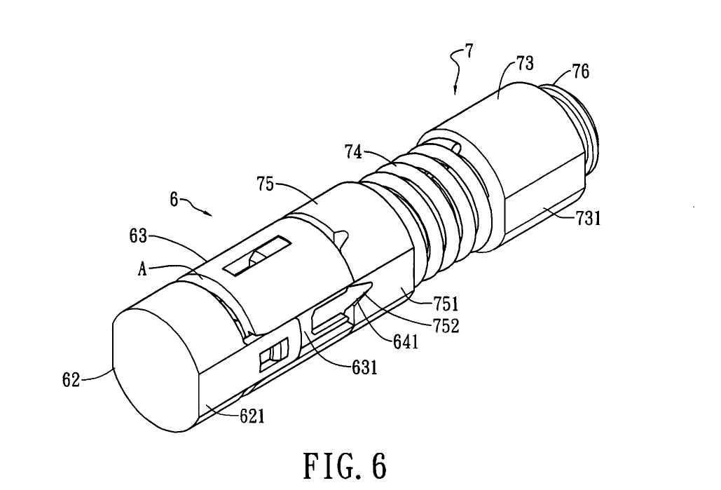

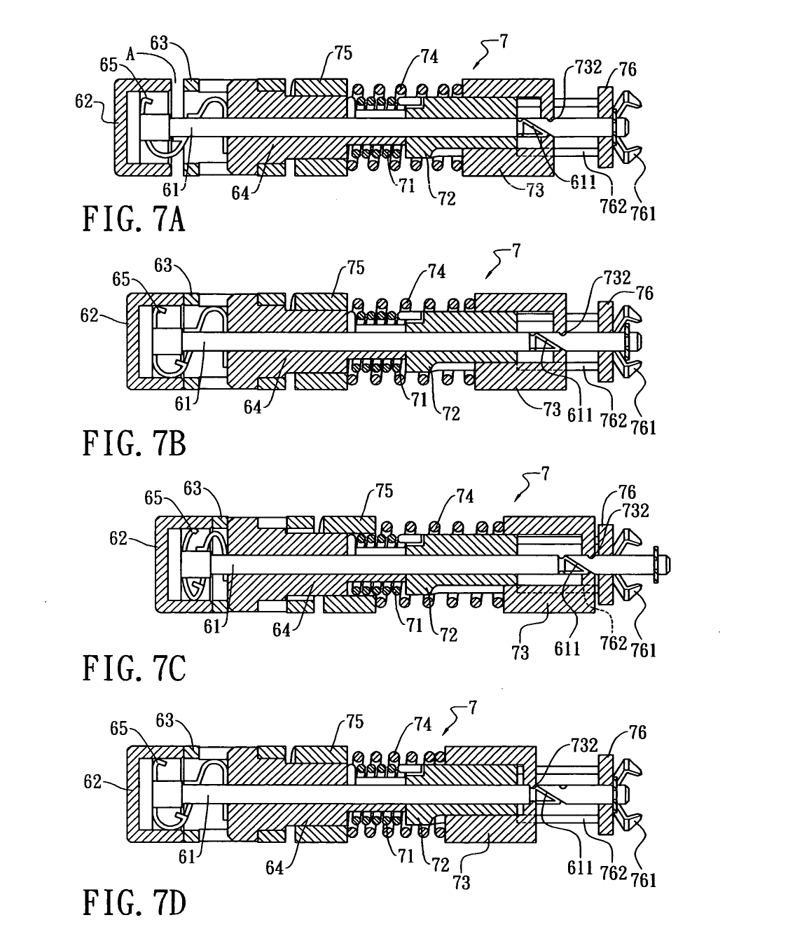

Referring to FIG. 6 and FIG. 7A to FIG. 7D, a perspective view and sectional motion capture views of a device for automatically flipping a handset cover, in accordance with the second embodiment of the present invention, are illustrated. The handset flip-up device can also be composed of a actuating member 6 and a rotating member 7, which integrates the reciprocating member 3 of the first embodiment into the actuating member 6 and the rotating member 7. The actuating member 6 includes an axial rod 61 penetrated through the rotating member 7, a actuating cap 62 disposed at one end of the axial rod 61. A button 63 is connected with the actuating cap 62 for moving the actuating cap 62 parallel to the button 63. The actuating cap 62 and the button 63 both include flat surface positioning portions 621, 631 disposed on two sides thereof, so as to be locked on the left frame of the main body 4 (as shown in FIG. 3). A positioning axial harness 64 is disposed in the button 63, which provides the button 63 to move thereon. An elastic element 65 is thrust in the axial rod 61, and contacts the positioning axial harness 64.

The rotating member 7 includes a torque spring 71 connected with the actuating member 6. The other end of the torque spring 71 is connected to a torque head 72. The torque head 2 is securely fastened in a pre-rotated head 73. In addition, a compressive spring 74 is disposed between the pre-rotated head 73 and the actuating member 6. A positioning portion 731 is formed at the outer rim of the pre-rotated head 73, while a connection portion 732 is disposed at one end of the pre-rotated head 73. Furthermore, one end of the axial rod 61 includes a triangular threaded groove 611 formed thereon. The threaded groove 611 occludes the connection portion, so as to rotate the pre-rotated head 73 on the axial rod 61, and performing lateral, radial, or axial movements. Moreover, the rotating member 7 further includes a positioning nut 75 contacting one end of the compressive spring 74. The positioning nut is disposed on the positioning axis harness 64, while the other end thereof is disposed corresponding the end of the button 63. A fastening element 76 is thrust behind the pre-rotated head 73. The fastening element 76 includes a mushroom head 71 disposed at one end thereof, thereby fastening the cover flipping device of the present invention along the left-right direction. In addition, the fastening element 76 employs two supporting arms 762 to penetrate the pre-rotated head 73 and contact the torque head 72, so as to prevent slipping to the right and allow the fastening element 76 to rotate about the torque head 73.

Referring to FIG. 7A to FIG. 7C, the actuating cap 62 and the button 63 are normally kept a distance A between each other. The actuating member 6 is disposed in the main body 4 of a headset, while the rotating member 7 is disposed in the cover 5 (as shown in FIG. 3. When the user operates the actuating cap 62 of the member 6, the end surface of the button 63 will contact the end surface of the positioning nut 75, thereby making the central axial rod 61 to drive the pre-rotated head 73 moving to the right. Meanwhile, the compressive spring 74 between the positioning nut 75 and the pre-rotated head 73 pushes the pre-rotated head 73 to move to the right. The positioning nut 75 is thus easily released from the positioning axis harness 64. Referring again to FIG. 7D, the pre-rotated head 73 is further driven and rotated by the torque from the torque spring 71, thereby flipping up the cover. At the same time, the pre-rotated head 73 will move to the left along the threaded groove 611 and push the compressive spring 74. The positioning nut 75 is then brought back to the original position, and locked on the positioning axial harness 64. On the contrary, when the cover is collected up, the pre-rotated head 73 is rotated following the cover, thereby making the connection portion 732 of the pre-rotated head 73 to occlude and rotate with the threaded groove 611 of the axial rod 61. When the cover is completed collected up, the pre-rotated head 73 will be pushed by the compressive spring 74 to move to the right along the threaded groove 61 of the axial rod 61, then moving back to the original position. Moreover, the operation of the pre-rotated head 73 and the axial rod 61 move along the lateral direction of the threaded groove 611, because the central axial rod 61 does not to rotate and the pre-rotated head 73 is driven by the cover. When the cover is collected up, the pre-rotated head 3 will move along the vertical direction of the threaded groove 611. Finally, when the cover is completed collected up, the pre-rotated head 73 will be pushed to the right by the compressive spring 74, and moved along the horizontal direction of the threaded groove 611 (as shown in FIG. 7A).

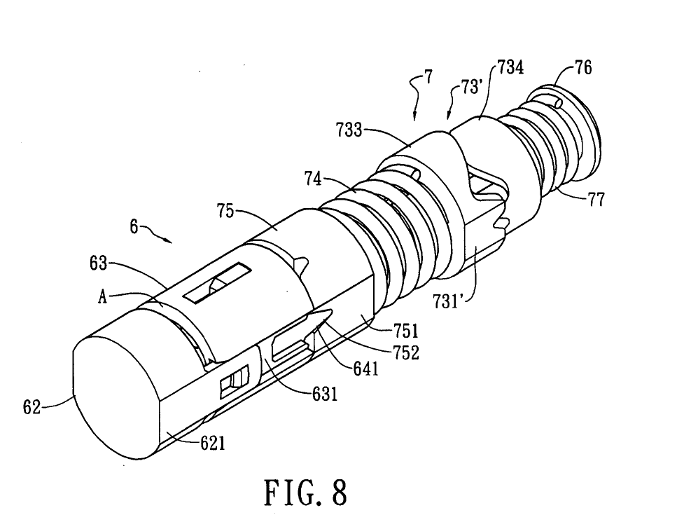

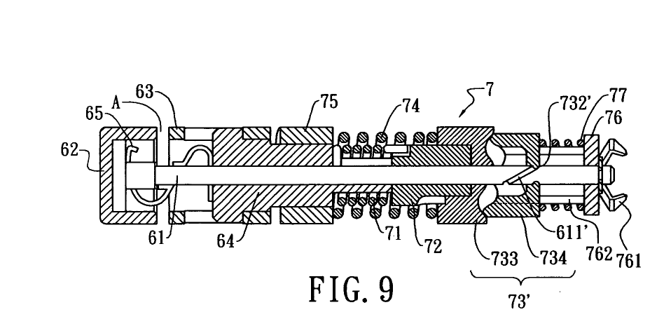

Referring to FIG. 8, a perspective view in accordance with the third embodiment of the present invention is illustrated. The third embodiment of the present invention replaces the pre-rotated head 73 in the second embodiment into a pre-rotated head 73′ composed of a left capstan 733 and a right capstan 734. The left capstan 733 acts as the rotating member, and the right capstan 734 acts as the reciprocating member. The left capstan 733 is thrust into the torque head 72 (as shown in FIG. 9), and two flat surface positioning portions 731′ is formed thereon opposite to each other. One end surface of the left capstan 733 includes a peak portion and a valley portion, while the right capstan 734 includes a connection portion 732′ disposed thereon (as shown in FIG. 9). The connection portion 732′ can be driven corresponding to the threaded groove 611′ of the axial rod 61. The right capstan 734 also includes a peak portion and a valley portion. Normally, the peak portions of the left capstan 733 and the right capstan 734 are mutually locked in position. In addition, a rotating spring 77 is disposed between the right capstan 734 and the fastening element 76.

Referring to FIG. 9, a sectional view of the third embodiment of the present invention is illustrated. When pressing the actuating cap 62, the axial rod 61 will move to the right. The axial rod 61 will drive the right capstan 734 to rotate a proper angle. The right capstan is then released from the locking position with the left capstan 733. Meanwhile, the normally compressed compressive spring 74 and the rotating spring 733 are immediately released, each pushing the left capstan 733, the right capstan 734 to slide towards the center. Such a movement, on the one hand, can easily push the positioning nut 75 to leave the positioning axial harness 64, while on the other hand, aid the cover to flip open due to the rotational torque towards the left exerted on the right capstan 734. When the cover is flipped up, the peak portion and the trough portion of the left capstan 733 and the right capstan 734 are connected with each other. When the cover is collected up, the right capstan 734 is driven again, which rotates towards the right and pushes the rotating spring 77 to return to its original position. Meanwhile, the left capstan 733 is also pushed towards the left. The peak portion and the trough portion of the left capstan 733 and the right capstan 734 are connected with each other again. In this manner, one can complete the operation of cover flip-up easily and repeatedly by pressing of a button.

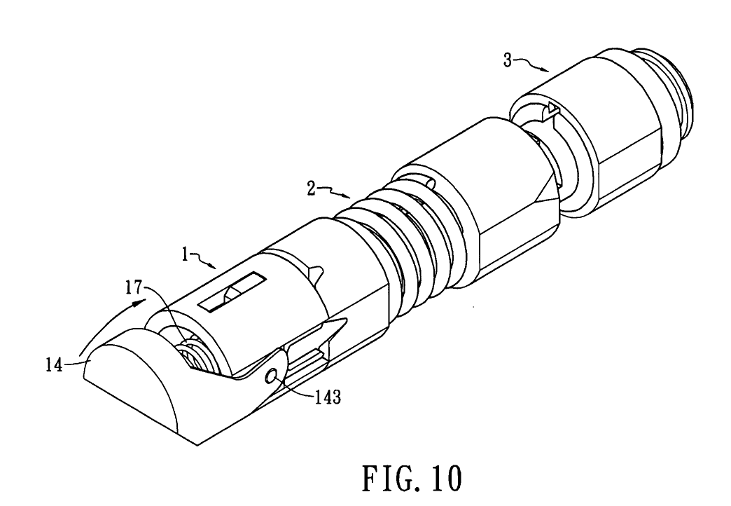

Referring to FIG. 10, a perspective view of the actuating cap of the present invention is illustrated. In addition to the actuating cap 14 described above, a protrusive point 143 can be disposed at two sides of the actuating cap 14. The two protrusive points 143 are used to lock the button 15. When the actuating cap 14 is not in use, it is extended with an inclined angle by the elastic element 17. When pressing the actuating cap 14, it is first moved to an upright position. This operation is similar to the other embodiments described above that a reducing pressure operation is performed in the first stage, thereby pushing the central axial rod 11 towards the right. In this manner, the actuating operation is easily completed.

In summary, the device for automatically flipping the cover of a handset of the present invention can indeed overcome the conventional drawbacks. The user of a handset can easily operate the actuating member to drive the rotating member with one single hand, and slide the reciprocating member to flip up the cover of the handset, thereby picking up a phone call. Therefore, the present invention can indeed satisfy the utility, novelty and non-obviousness requirements in the patent law, a grant of letters patent for the present invention is thus respectfully requested.

Since, any person having ordinary skill in the art may readily find various equivalent alterations or modifications in light of the features as disclosed above, it is appreciated that the scope of the present invention is defined in the following claims. Therefore, all such equivalent alterations or modifications without departing from the subject matter as set forth in the following claims is considered within the spirit and scope of the present invention.

What is claimed is:

1. A device for automatically flipping a handset cover, comprising:
an actuating member;
a rotating member, movably connected to the actuating member; and
a reciprocating member, movably connected to one end of the rotating member; whereby the handset cover is flipped by operating the actuating member to push the rotating member, and drive the reciprocating member to generate a rotation.

2. The device as recited in claim 1, wherein the actuating member comprises an axial rod penetrated through the rotating member and the reciprocating member, an actuating cap disposed at one end of the axial rod, a button connected with the actuating cap, a positioning axis harness disposed in the button, and an elastic element thrust in the axial rod and contacted with the positioning axis harness.

3. The device as recited in claim 2, wherein a distance is normally formed between the two opposite surfaces of the actuating cap and the button.

4. The device as recited in claim 2, wherein a pillar and a narrowed section is formed on the axial rod, wherein the pillar is a square pillar, a polygonal pillar, or a pillar of other geometrical forms.

5. The device as recited in claim 2, wherein the actuating cap comprises a groove hole formed thereon, and the button comprises a protrusive portion connected with the groove hole, the length of the groove hole being larger than that of the protrusive portion.

6. The device as recited in claim 2, wherein a long groove is disposed on the button, and a protrusive piece connected with the long groove is disposed on the positioning axial harness, the length of the long groove being larger than that of the protrusive piece.

7. The device as recited in claim 1, wherein the rotating member comprises a torque spring connected with the actuating member, a torque head connected with the torque spring, a hook connected with the torque head, a pre-rotated head thrust on the pre-rotated head, a compressive spring thrust on the torque head and contacted one end of the pre-rotated head, and a positioning nut contacted the other end of the compressive spring.

8. The device as recited in claim 7, wherein the torque head comprises two corresponding concave grooves formed thereon, and the inner wall of the pre-rotated head comprises two protrusive portions corresponding to the concave grooves, the protrusive portions and the concave grooves being shifted with a predetermined angle between each other.

9. The device as recited in claim 7, wherein a positioning portion is formed around the pre-rotated head.

10. The device as recited in claim 9, wherein the positioning portion of the pre-rotated head is a single flat surface, two mutually parallel flat surfaces, or a protrusive surface.

11. The device as recited in claim 10, wherein a reverse horn is formed at one end of the positioning portion of the pre-rotated head.

12. The device as recited in claim 1, wherein the reciprocating member comprises an inner track nut pivotally connected with the rotating member, a fastening head for the inner track nut to thrust therein, and a slipping piece disposed between the inner track nut and the fastening head.

13. The device as recited in claim 12, wherein a circular shaft is formed at the central portion of the fastening head, and two cropping grooves are formed around the rim of the fastening head.

14. The device as recited in claim 12, wherein two protrusive pillars are formed around the slipping piece, the slipping piece being thrust in the circular shaft of the fastening head, and the protrusive pillars being embedded in the cropping grooves of the fastening head.

15. A device for automatically flipping a handset cover, comprising:
an actuating member; and
a rotating member, movably connected to the actuating member; whereby the handset cover is flipped by operating the actuating member to push the rotating member.

16. The device as recited in claim 15, wherein the actuating member comprises a axial rod penetrated through the rotating member, an actuating cap disposed at one end of the axial rod, a button connected with the actuating cap, a positioning axial harness disposed in the button, and an elastic element thrust in the axial rod and contacted the positioning axial harness.

17. The device as recited in claim 16, wherein a distance is normally formed between the two opposite surfaces of the actuating cap and the button.

18. The device as recited in claim 15, wherein the rotating member comprises a torque spring connected with the actuating member, a torque head connected with one end of the torque spring, a pre-rotated head securely fastened to the outside of the torque head, a compressive spring thrust on the torque head and contacted one end of the pre-rotated head, a positioning nut contacted the other end of the compressive spring, and a fastening element thrust behind the pre-rotated head.

19. The device as recited in claim 18, wherein a connection portion is formed on the pre-rotated head, and a threaded groove is formed on the actuating member, the threaded groove being occluded with the connection portion.

20. The device as recited in claim 18, wherein the pre-rotated head comprises a left capstan functions as the rotating member and a right capstan functions as the reciprocating member, the left capstan and the right capstan having a peak portion and a trough portion formed on the opposite end surfaces.
